(19) United States
(12) Patent Application Publication
(10) Pub. No.: US 2020/0193779 A1
(43) Pub. Date: Jun. 18, 2020

(54) TRIVIA GAME AND METHOD OF PLAY

(71) Applicant: FLEETWIT INC., New York, NY (US)

(72) Inventors: David Metz, New York, NY (US); Brett Lazer, Brooklyn, NY (US)

(21) Appl. No.: 16/221,137

(22) Filed: Dec. 14, 2018

(51) Int. Cl. G07F 17/32

(52) U.S. Cl. CPC G07F 17/3293; G07F 17/322; G07F 17/3276; G07F 17/3269

(57) ABSTRACT

A trivia card game for two or more players includes at least one trivia game card and at least two entry devices. An entry device is assigned to each of the players. Each trivia game card includes at least a first question indicia, a game question indicia and an answer to the game question indicia. During game play, the first question indicia is communicated to the players and at least a first betting round is initiated. After the first question indicia has been communicated to the players, the game question indicia is communicated to the players. The players enter their respective answers to the game question indicia on the entry devices. The answers on the entry devices are compared to the answer to the game question indicia embodied on the trivia game card to determine which player answered the game question indicia correctly.

### BACKGROUND OF THE INVENTION

### Field of the Invention

The present invention generally relates to card games, and more specifically relates to trivia card games and methods of play.

### Description of the Prior Art

Trivia games and trivia contests are widely popular in educational and recreational settings. In most trivia games, a player is asked a particular trivia game question and awarded if the player's answer to the trivia game question is correct. Accordingly, a player's skill at playing trivia games is attributed primarily to the player's personal knowledge of a variety of subject matter. Some trivia games are played with a group of two or more players, wherein the number of trivia game questions that each player correctly answers is tabulated. The player who answers the greatest number of questions is often deemed to be the winner.

In most trivia games, the interaction between each player is fairly limited. More specifically, players are read a trivia game question and each player's specific answer is compared to a predetermined correct answer to the trivia game question. Any competition between the players of the trivia game is attributed to mere personal knowledge of a variety of subject matter as opposed to strategy. In contrast, multi-player poker games incorporate inter-player strategy. For example, each player may assess another player to gauge whether the player has a winning hand. Bluffing, bluff-catching, manipulating bet size, intimidation and a player's historic play strategies are all utilized as part of the game play to leverage opponents. However, poker games are based more on inter-player strategy and chance than broad personal knowledge of a variety subject matters.

Accordingly, commonly known trivia games and poker games each lack an aspect of game play that is desirable to frequent card game players.

### OBJECTS AND SUMMARY OF THE INVENTION

It is an object of the present invention to provide a trivia card game.

It is another object of the present invention to provide a trivia game card for a trivia card game.

It is a further object of the present invention to provide a method for playing a trivia card game that incorporates both inter-player strategy and personal knowledge of a variety of subject matter.

It is yet a further object of the present invention to provide a system and method for playing a trivia card game that incorporate both inter-player strategy and personal knowledge of a variety of subject matter.

In accordance with one form of the present invention, a trivia card game for two or more players includes at least one trivia game card and at least two entry devices. Each trivia game card includes at least a first question indicia, a game question indicia and an answer to the game question indicia imprinted thereon. Alternatively, each trivia game card may be embodied as an electronic trivia game card file, wherein the first question indicia, the game question indicia and the answer to the game question indicia are electronically embedded therein. The entry devices receive each player's answer to the game question indicia.

As stated previously, a method for playing a trivia card game that incorporates both inter-player strategy and personal knowledge of a variety of subject matter is also disclosed. The method comprises the steps of retrieving the first question indicia from the trivia game card, communicating the first question indicia to the players, initiating a first betting round, retrieving the game question indicia from the trivia game card, communicating the game question indicia to the players and initiating a first answering round. During the first answering round, each player's answer to the game question indicia is input to each player's respective entry device.

In another embodiment of the present invention, a trivia card game system for two or more players includes at least one electronic trivia game card file, a central computer and at least two entry devices, wherein the electronic trivia game card file is stored in the central computer and wherein the central computer is in communication with each of the entry devices. Each electronic trivia game card file includes at least a first question indicia, a game question indicia and an answer to the game question indicia electronically embedded therein. The central computer includes a processor and a memory, such as a non-transitory computer-readable storage medium. Each of the entry devices preferably includes a processor, a user interface and a display, wherein the game question indicia is displayed on the display and a respective player's answer to the game question indicia is input to the entry device via the user interface thereof.

As also stated previously, a method for playing a trivia card game utilizing a trivia game system is disclosed. The method comprises the steps of communicating the first question indicia from the central computer to the at least two entry devices, displaying the first question indicia on the display of each entry device, initiating a first betting round, communicating the game question indicia from the central computer to the entry devices and initiating a first answering round. During the first answering round, the players input their respective answers to the game question indicia to the entry devices via the user interface. After the players input their answers to the entry devices, the answers are communicated to the central computer and the central computer compares the players' answers to the game question indicia to the answer to the game question indicia embedded in the electronic game card file.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is top plan view of the game table of the trivia game formed in accordance with one embodiment of the present invention.

FIG. 2 is a front view of the trivia game card of the trivia game formed in accordance with one embodiment of the present invention.

FIG. 3 is a rear view of the trivia game card of the trivia game formed in accordance with one embodiment of the present invention.

FIG. 4 is a front view of the timer of the trivia game formed in accordance with one embodiment of the present invention.

FIG. 5 is a front view of the entry device of the trivia game formed in accordance with one embodiment of the present invention.

FIG. 6 is a front view of the card viewer of the trivia game formed in accordance with one embodiment the present invention, showing the trivia game card partially received therein.

FIG. 7 is a top view of the sealed trivia game card pack of the trivia game formed in accordance with one embodiment of the present invention.

FIG. 8 is a block diagram of an electronic trivia game system formed in accordance with one embodiment of the present invention.

FIG. 9 is a front view of an exemplary trivia game card of the trivia game formed in accordance with one embodiment of the present invention.

FIG. 10 is a front view of the electronic entry device of the trivia game formed in accordance with one embodiment of the present invention

### DETAILED DESCRIPTION OF THE PREFERRED EMBODIMENTS

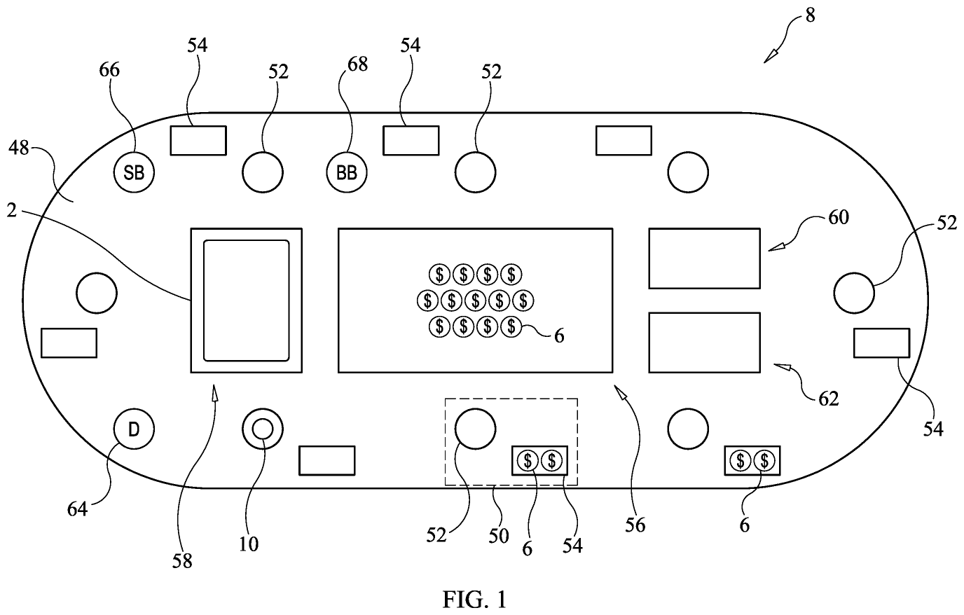

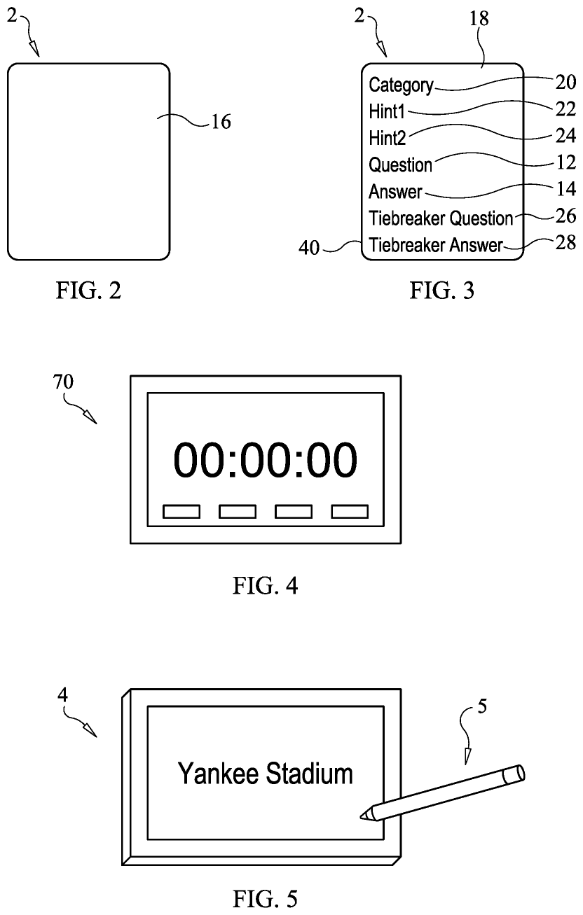

Referring to FIGS. 1-7 and 8 of the drawings, it will be seen that a trivia game formed in accordance with the present invention preferably includes at least one trivia game card 2, at least two entry devices 4 and wagering indicia 6. The trivia game may further comprise a game table or game board 8 on which the trivia game is played and at least one fold marker 10. The trivia game formed in accordance with the present invention may be played by two or more players.

The trivia game card 2 preferably includes at least one game question indicia 12 and an answer 14 to the game question indicia 12 displayed (e.g., imprinted) thereon. As will be described in greater detail in the forthcoming paragraphs, during game play, the game question indicia 12 on the trivia game card 2 is communicated (e.g., read or displayed) to the game players. The trivia game card 2 preferably includes a first side 16 and a second side 18 situated opposite the first side 16. The second side 18 of the trivia game card 2 includes at least one question indicia.

In a preferred embodiment of the trivia game formed in accordance with the present invention, the second side 18 of the trivia game card 2 includes at least one of a first question indicia 20, a second question indicia 22, a third question indicia 24 and the game question indicia 12. The first question indicia 20 may be a category relating to a particular subject matter. For example, the first question indicia 20 on the trivia game card 2 may be one of the following categories: literature and language; the arts; pop culture; sports and games; leisure and lifestyle; potpourri; science and technology; history and social sciences; and current events. The second question indicia 22 is preferably a subcategory of the first question indicia 20 and may also be referred to as “the first hint”. The third question indicia 24 is preferably a subcategory of the second question indicia 22 and may also be referred to as “the second hint”. More specifically, the first question indicia 20 may comprise a first trivia category, the second question indicia 22 may comprise a second trivia category and the third question 24 indicia may comprise a third trivia category, wherein the second trivia category is a subcategory of the first trivia category, the third trivia category is a subcategory of the second trivia category and the game question indicia 12 comprises a question common to the first through third trivia categories.

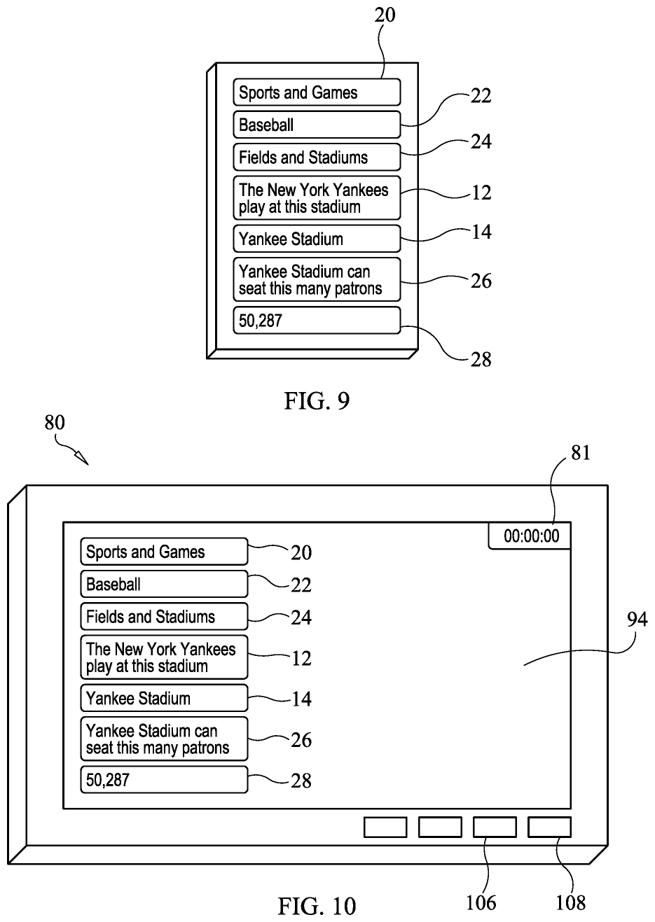

As shown in FIG. 9 of the drawings, one example of the question indicia on the trivia game card 2 is as follows: the first question indicia 20 comprises the category “Sports and Games”; the second question indicia 22 or “the first hint” comprises the category “Baseball”; the third question indicia 24 or “the second hint” comprises the category “Fields and Stadiums”; and the game question indicia 12 is the question “The New York Yankees play at this stadium”. In this particular example, the answer 14 to the game question indicia 12 shown on the trivia game card 2 would be “Yankee Stadium”.

The trivia game card 2 may further comprise a tie-breaker question indicia 26 and an answer 28 to the tie-breaker question indicia 26. As will be explained in greater detail in the forthcoming paragraphs, if no player answers the game question indicia 12 correctly, the tie-breaker question indicia 26 may be utilized as a follow-up question to the game question indicia 12. Preferably, the tie-breaker question indicia 26 is a question that has a numerical answer so that there is an increased likelihood of a single player being the winner of the game round such that the game round is concluded. In accordance with the exemplary question indicia set forth on the trivia game card 2 described in the previous paragraph and shown in FIG. 9 of the drawings, the tie-breaker question indicia 26 could be: “Yankee Stadium can seat this many patrons”. The answer 28 to the tie-breaker question indicia 26 set forth on the trivia game card 2 would be “50,287”. Accordingly, the player who answered the tie-breaker question indicia 26 with the number closest to “50,287” would win the round.

Although the preferred embodiment and examples of the trivia card game 2 set forth in previous paragraphs describe a trivia game card 2 with five question indicia, it is envisioned to be within the scope of the present invention to have any number of question indicia on the trivia game card 2. For example, the trivia game card 2 could include only the first question indicia 20, in which case the first question indicia 20 would be the game question. Alternatively, the trivia game card 2 could have three question indicia, wherein the first question indicia 20 corresponds to a category, the second question indicia 22 is the game question and the third question indicia 24 is the tie-breaker question.

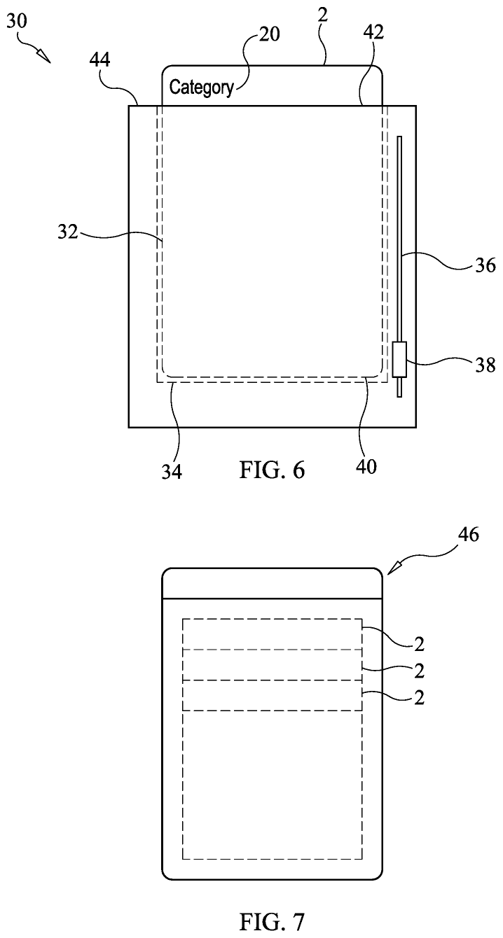

The trivia game formed in accordance with the present invention may further include a card viewer 30. As shown in FIG. 6 of the drawings, one or more trivia game cards 2 may be inserted into the card viewer 30 such that one or more question indicia on the trivia game card 2 are selectively obscured so that, if a player is reading the question indicia during game play, only a specific question indicia is visible at a given time. The card viewer 30 preferably includes a housing 32 defining an internal cavity 34 into which one or more trivia game cards 2 are at least partially received. The trivia game card 2 is selectively removable from the internal cavity 34 of the card viewer 30 such that at least one of the question indicia is visible. The housing 32 may further include a slot 36 in communication with the internal cavity 34 through which a lever 38 extends. The lever 38 is preferably reciprocatingly movable along the length of the slot 36. At least a portion of the lever 38 is in communication with a bottom portion 40 of the trivia game card 2 such that, as the lever 38 reciprocates within the slot, the lever 38 biases the trivia game card 2 outwardly from an opening 42 formed in the top 44 of the card viewer 30.

For example, in a first round of the trivia game formed in accordance with the present invention, the trivia game card 2 is adjusted in the card viewer 30 such that only the first question indicia 20 is visible. After a betting round ends, the trivia game card 2 is adjusted again in the card viewer 30 such that the second question indicia 22 is visible and the third question indicia 24, game question indicia 12, answer 14 to the game question indicia 12, tie-breaker question indicia 26 and answer 28 to the tie-breaker question indicia 26 are obscured. The trivia game card 2 is progressively adjusted in the card viewer 30 until the game question indicia 12 has been read and/or displayed and each player has designated his or her answer to the game question indicia 12 on the entry device 4. Thereafter, the trivia game card 2 may be once again adjusted in the card viewer 30 so that the answer 14 to the game question indicia 12 is displayed. In the event that no player answers the game question indicia 12 correctly, the trivia game card 2 may be adjusted in the card viewer 30 such that the tie-breaker question indicia 26 is displayed. After the tie-breaker question indicia 26 has been displayed and each player's answer to the tie-breaker question indicia 26 has been entered, the trivia game card 2 may again be adjusted to display the answer 28 to the tie-breaker question indicia 26.

The use of the card viewer 30 allows each player to act as a host and read the question indicia while playing the game without gaining an unfair advantage. If the trivia game is being played with a non-player host, the non-player host may either read the trivia game card 2 directly or utilize the card viewer 30. As can be seen in FIG. 7 of the drawings, the trivia game formed in accordance with the present invention may include a sealed pack 46 that comprises a plurality of trivia game cards 2. Additional sealed packs 46 of trivia game cards 2 can be supplied or purchased separately from the trivia game to update the available game question indicia or to replace the question indicia with game question indicia from a specific category (e.g., literature and language; the arts; pop culture; sports and games; leisure and lifestyle; potpourri; science and technology; history and social sciences; and current events, etc.). The sealed pack 46 of trivia game cards 2 may be specific to a particular category or may include a plurality of categories. If a tournament is being conducted, the sealed pack 46 of trivia game cards 2 ensures that the trivia game cards 2 and question indicia set forth thereon have not been viewed by game players or non-player hosts prior to the start of the tournament.

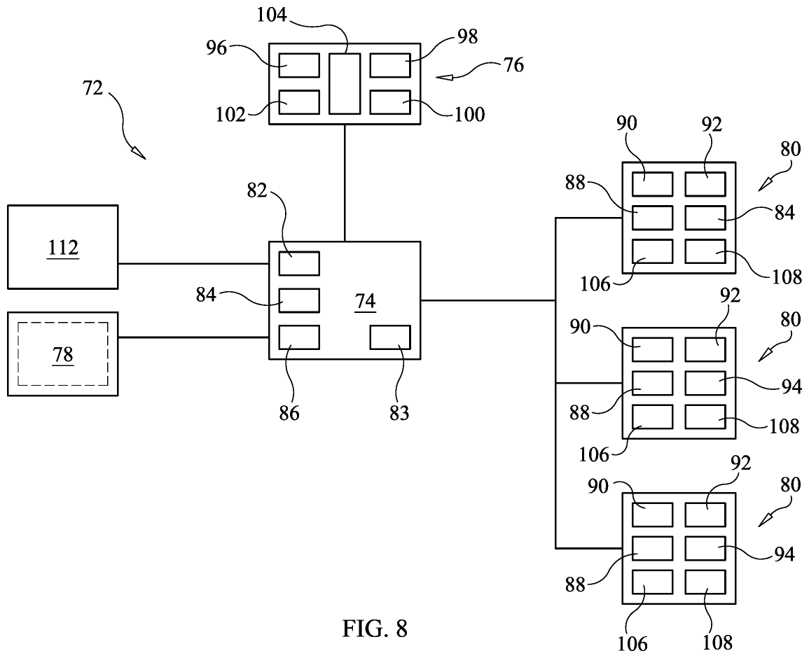

Each player is assigned an entry device 4. The entry device 4 is utilized to receive a player's answer to the game question indicia 12 and, if necessary, a player's answer to the tie-breaker question indicia 26. The entry device 4 may have various forms. For example, in the simplest form, the entry device 4 may be a pad of paper or a dry erase board, as shown in FIG. 5 of the drawings. In a more complex system, the entry device 4 may be an electronic entry device 80 such as a computerized tablet or mobile phone that is capable of receiving an input from the player via a user interface 94, as shown in FIGS. 8 and 10 of the drawings.

During game play, prior to the start of a hand or during a betting round, each player may place wagers with wagering indicia 6. The wagering indicia 6 may be currency (e.g., dollars), chips or the like. Depending on the type of game play (e.g., tournament or by-the-hand), the players may “buy in”, for example at the beginning of a tournament, and be assigned a specific amount of wagering indicia 6 (e.g., chips) for use during game play.

The trivia game may further comprise a game table or a game board 8. The game table or game board 8 preferably includes a top surface 48 having markings or sections designating a plurality of game play regions 50. For example, the top surface 48 of the game table or game board 8 may be formed of a felt material and have markings or sections to designate a game play region 50 for each player. Each game play region 50 is situated in front of a player's seat and preferably includes additional markings or sections designating a first sub-region 52 and a second sub-region 54. Each of the first sub-region 52 and the second sub-region 54 may be designated by a variety of shapes and/or patterns. For example, a circular marking may be utilized to designate the first sub-region 52, whereas a square marking may be utilized to designate the second sub-region 54.

In one embodiment, at the beginning of each hand, each player moves his or her fold marker 10 into the first sub-region 52 to indicate to the dealer and other players that the player is engaged or committed to playing the hand (e.g., the player is “in”). If a player wants to fold during the hand, he or she removes his or her folder marker 10 from the first sub-region 52 to indicate his or her decision to fold (e.g., the player is “out”). The fold marker 10 is generally a small object or talisman like a coin or a game piece. Preferably, the fold marker 10 has some personal significance to the player and provides an additional fodder for developing a specific player's backstory. For example, a player who likes boats may have a personalized fold marker depicting a boat. Each player may provide their own personalized fold marker 10 or may utilize fold markers 10 provided with the trivia game formed in accordance with the present invention.

During a wagering or betting round, each player may bet a particular amount of wagering indicia 6, such as chips or currency, and place such wagering indicia 6 in the second sub-region 54. When a player places such wagering indicia 6 in the second sub-region 54, it indicates to the dealer and other players that the player has committed that particular amount of wagering indicia 6 to the bet at hand.

The top surface 48 of the game table or game board 8 may also include a plurality of other marked regions. For example, the top surface 48 may further include at least one of a marked center pot region 56, a marked region 58 for trivia game cards 2 or the card viewer 30, a used card storage region 60 and a category breakdown region 62, wherein statistics of the categories of the game question indicia 12 are tabulated. As will be explained in greater detail in the forthcoming paragraphs, after a betting round has ended and each player has placed a specific wagering indicia 6 in the second sub-region 54 or folded, each player's wagering indicia 6 is moved to the center pot region 56.

In a tournament style setting, players of the trivia game formed in accordance with the present invention sit in front of a particular game play region 50 of the game table or game board 8. Any of the players may act as the dealer during a particular round or hand. The dealer reads the question indicia from the trivia game card 2. If one of the players is acting as the dealer, one or more trivia game cards 2 are loaded into the card viewer 30 so that one or more of the question indicia are at least partially obscured to the player acting as the dealer.

A dealer button 64 may be utilized to indicate which player is acting as the dealer during a particular hand. At the end of each hand, the dealer button 64 may be moved to the next sequential player. For example, at the end of a hand, the dealer button 64 may be moved from one player to an adjacent or next player in a clockwise direction around the game table or game board 8. Alternatively, a non-player may act as the dealer. For example, a “host” may also participate in the trivia game. The host is a non-player who reads the question indicia from the trivia game card 2 during game play. Additionally, one or more non-player assistants may assist the dealer or host with various game play tasks, such as collecting bets, retrieving and storing trivia game cards 2, collecting statistics throughout the hand and game, and moving various game pieces (e.g., the dealer button 64, the blind markers 66, 68, wagering indicia 6 and trivia game cards 2, etc.) about the game table or game board 8.

Furthermore, one or more non-player judges may participate in the trivia game. The non-player judges rule on the acceptability of the players' answers to the game question indicia 12 entered by each respective player and, if necessary, the players' answers to the tie-breaker question indicia 26. For example, the judges may compare the players' answers to at least one of the game question indicia 12 and the tie-breaker question indicia 26 to the answer 14 to the game question indicia 12 and the answer 28 to the tie-breaker question indicia 26 set forth on the trivia game card 2. The judges may also rule on issues such as spelling, specificity of answers and possible alternative acceptable answers. In particular types of game play, such as in a tournament, the judges may receive the game questions ahead of time so that the judges can research and prepare for possible issues.

The trivia game may also be played with one or blinds to stimulate game play and game progression. A blind is a required wager that one or more players must make before the first question indicia 20 of the trivia game card 2 is read or displayed at the start of a hand. For example, the trivia game may utilize a “small blind” and a “big blind”. The big blind is preferably twice the amount of the small blind. Markers for each blind may also be utilized and situated on the game table or game board 8 in front of the particular player who is required to wager a blind. More specifically, a small blind marker 66 is situated in front of the player that is situated to the adjacent-left of the dealer or dealer button 64. A big blind marker 68 is situated in front of the player who is positioned to the adjacent-left of the player positioned in front of the small blind marker 66. At the end of each round, as the dealer button 64 rotates clockwise around the game table or game board 8, the small blind marker 66 and the big blind marker 68 also rotate clockwise around the game table or game board 8 such that their relative position to the dealer or dealer button 64 is preserved. Accordingly, at the start of each new hand, a new player will be positioned in front of each of the small blind marker 66 and big blind marker 68.

In a preferred embodiment of the trivia game formed in accordance with the present invention, at the start of a round, each participating player positions his or her fold marker 10 into the first sub-region 52 of the player's respective game play region 50 to indicate to the dealer and the other players that the player is engaged or committed to playing the hand (e.g., the player is “in”). If the trivia game is being played with blinds such as a small blind and big blind, the players sitting in front of the blind markers 66, 68 bet their respective blind.

After the blinds have been bet, the dealer reads the first question indicia 20 or category from the trivia game card 2. For example, the first question indicia 20 may be the category “Sports and Games”. After the first question indicia 20 has been read or “revealed”, a first round of betting commences during which each participating player can either fold, check, bet, call or raise. Betting starts with the player to the adjacent-left of the player situated in front of the big blind marker 68 and proceeds clockwise.

More specifically, in any particular round of betting, if a player wishes withdraw from further play in the hand or “fold”, the player removes his or her fold marker 10 from the first sub-region 52 of the player's respective game play region 50 to indicate to the dealer his or her decision. Any blinds wagered by a player or players that fold are forfeited and are not returned to the player. A player may also “bet” during a betting round by wagering a particular amount of wagering indicia 6, such as chips or currency. In response to a “bet” by a player, other players must “call” the player's bet and match the bet or “raise”, whereby the player increases the amount of the bet. If no bets have been placed, a player may “check” or pass. However, if a subsequent player bets, any prior players who checked must either call, raise or fold. During betting, each player may be allocated a specific time period to bet during the betting round (e.g., 30 seconds). Each player's respective wagering indicia 6 for a particular bet, raise or call are positioned in the second sub-region 54 of the player's respective game play region 50. A timer 70 or the like may be utilized to keep track of each player's remaining time for betting during a particular round. At the conclusion of each betting round, the wagering indicia 6 in the second sub-region 54 of each player's respective game play region 50 are moved to the center pot region 56.

After the waging indicia 6 from the first round of betting have been moved to the center pot region 56, the dealer reads the second question indicia 22 or the “first hint” from the trivia game card 2. As explained previously, the second question indicia 22 or the “first hint” is preferably a subcategory of the first question indicia 20. For example, the second question indicia 22 may be “Baseball”, which is a subcategory of the first question indicia 20 “Sports and Games”. After the second question indicia 22 has been read or “revealed”, a second round of betting commences. The second round of betting follows substantially the same process as the first round of betting.

After the waging indicia 6 from the second round of betting have been moved from the second sub-region 54 of each player's respective game play region 50 to the center pot region 56, the dealer reads the third question indicia 24 or the “second hint” from the trivia game card 2. As explained previously, the third question indicia 24 or the “second hint” is preferably a subcategory of the second question indicia. For example, the third question indicia 24 may be “Fields and Stadiums”, which is a subcategory of the second question indicia 22 “Baseball”. After the third question indicia 24 has been read or “revealed”, a third round of betting commences. The third round of betting follows substantially the same process as the first and second rounds of betting.

After the waging indicia from the third round of betting have been moved from the second sub-region 54 of each player's respective game play region 50 to the center pot region 56, the dealer reads the game question indicia 12 from the trivia game card 2. For example, the game question indicia 12 may be “The New York Yankees play at this stadium”. After the game question indicia 12 or “game question” has been read or revealed, the players may be allocated a specific period of time (e.g., 60 seconds) to enter their answer on their respective entry devices 4. After a player has entered his or her answer, the player locks his or her entry device 4 to indicate that their respective answer is complete. In the simplest form, a player may turn his or her entry device over to signify that their answer is final and complete (e.g., “locked”). Additionally, the dealer may prohibit any answers from the players after the time period has ended. In a more complex system wherein the entry device is electronic, any answer thereon may be electronically locked after either the player indicates that the answer is complete or the time period for answering the game question has ended. Additionally, the electronic entry device 80 may have an external or internal timer 81 such that the device automatically locks after a predetermined period of time has elapsed.

After each player's answer has been entered or the time period for entering an answer has ended, each player's respective answer is revealed, one-by-one in a clockwise direction, starting with the player situated adjacent-left to the dealer. After each player's answer has been revealed, the dealer reads or displays the answer 14 to the game question indicia 12 from the trivia game card 2. The dealer or judges then compare each player's respective answer to the game question indicia 12 to the answer 14 to the game question indicia 12 set forth on the trivia game card 2. If only one player entered the correct answer, he or she is awarded all of the wagering indicia 6 situated in the center pot region 56. If more than one player entered the correct answer, the wagering indicia 6 in the center pot region 56 is split evenly among such players. If no player entered a correct answer, the game proceeds to a tie-breaker round.

During the tie-breaker round, the dealer reads the tie-breaker question indicia 26 or “tie-breaker question” from the trivia game card 2. As explained previously, the tie-breaker question indicia 26 is preferably a question that has a numerical answer so that there is an increased likelihood of a single player being the winner of the game round such that the game round is concluded. For example, the tie-breaker question indicia 26 could be: “Yankee Stadium can seat this many patrons”. After the tie-breaker question indicia 26 has been read or revealed, the players may be allocated a specific period of time (e.g., 30 seconds) to enter their answer on their respective entry devices 4. After a player has entered his or her answer, the player locks his or her entry device 4 to indicate that their respective answer is complete.

After each player's answer has been entered or the time period for entering an answer has ended, each player's respective answer is revealed, one-by-one in a clockwise direction, starting with the player situated adjacent-left to the dealer. After each player's answer has been revealed, the dealer reads or displays the answer 28 to the tie-breaker question indicia 26 from the trivia game card 2. For example, the answer 28 to the tie-breaker question indicia 26 set forth on the trivia game card 2 would be “50,287”. The dealer or judges then compare each player's respective answer to the tie-breaker question indicia 26 to the answer 28 to the tie-breaker question indicia 26 set forth on the trivia game card 2. Accordingly, the player who answered a number closest to “50,287”, regardless of whether the answer goes over the numerical answer to the tie-breaker question indicia 26, wins the round and all of the wagering indicia 6 in the center pot region 56. If two or more players answers are equally close to the answer 28 to the tie-breaker question indicia 26, the wagering indicia 6 in the center pot region 56 can be split between them.

After the round is complete, the method of game play repeats. The previously used trivia game card 2 is discarded or situated on the portion 60 of the game table or game board 8 marked for discarded cards. The dealer button 64 and blind markers 66, 68 are rotated clockwise around the game table or game board 8. Players who are participating in the round move their respective fold marker 10 into the first sub-region 52 of the player's respective game play region 50. After the required blinds are wagered on the game table or game board 8, the dealer draws a new trivia game card 2 and a subsequent hand is played. The blinds may be increased at various points throughout the game.

The trivia game formed in accordance with the present invention may terminate at various stages depending on the particular style of game play. If the game is being played as a tournament, players purchase an equal amount of wagering indicia 6 prior to the first round. The purchased funds are stored in a “game pot”, which is separate from the center pot region 56. As the game proceeds, if a player loses all of his or her wagering indicia 6, at certain points in the game, players may be offered the opportunity to obtain replacement wagering indicia 6 or “buy back in”. The funds used to “buy back in” are added to the game pot. In the tournament style of play, the trivia game formed in accordance with the present invention ends when only one player remains and he or she has won all of the wagering indicia 6 (e.g., all of the other players lost their wagering indicia). The winner is awarded all of the funds in the game pot. Alternatively, the game may end when a certain amount of players remain (e.g., three) and the funds in the game pot are distributed to the three remaining plays in a ratio proportionate to their respective remaining wagering indicia 6. Alternatively, the players may be ranked based on their remaining wagering indicia 6 (e.g., 1^{st}, 2^{nd} and 3^{rd}) and each rank may have a specific monetary award from the funds. If the trivia game formed in accordance with the present invention is being played by the hand, each player may merely collect his or her winning wagering indicia 6 at the end of each hand and leave the game.

Game statistics may be collected relating to the previous round, including player performance. For example, collected player performance statistics may include a player's performance on different categories and subcategories, a player's betting tendencies, players' records in head-to-head showdowns. Additionally, collected game play statistics may include which categories tend to be easiest/hardest in general.

In another embodiment of the trivia game formed in accordance with the present invention, the trivia game includes a game system 72 that comprises at least one central computer 74, at least one control unit 76, at least one display 78 and at least two electronic entry devices 80, wherein the central computer 74 is in communication with each of the control unit 76, display 78 and electronic entry devices 80. The display 78 may be local or remote (e.g., viewable online or at remote locations). The central computer 74 preferably includes a processor 82, a memory 84, such as a non-transitory computer-readable storage medium, a timer 86 and a user interface 83. The electronic entry device 80 preferably includes a processor 88, a memory 90, such as a non-transitory computer-readable storage medium, a display 92 and a user interface 94 that receives an input from the player. In a preferred form, the electronic entry device 80 is an electronic tablet. In its simplest form, the control unit 76 may be or include a button or actuator 96 that is actuatable by a player or non-player to send an activation signal to the central computer 74. In a preferred form, the control unit 76 is an electronic tablet having a processor 98, a memory 100, such as a non-transitory computer-readable storage medium, a display 102 and a user interface 104 that receives an input from a player or non-player. Each non-transitory computer-readable storage medium may include at least one of a random access memory (RAM), a dynamic random access memory (DRAM), a digital storage disk and a read only memory (ROM).

The game system 72 for the trivia game formed in accordance with the present invention can be used during tournaments in which there is a viewing audience (e.g., a local audience, a television audience or an online audience, etc.). More specifically, the game system 72 enables the trivia game formed in accordance with the present invention to be played more efficiently and allows the viewing audience to be better apprised of the actions occurring during game play. When the game system 72 is utilized, the method of playing the trivia game generally follows the steps described in the preceding paragraphs. After the game question indicia 12 has been read or revealed, a player or non-player actuates the control unit 76 which, in response thereto, sends a first signal to the processor 82 of the central computer 74. Upon receiving the first signal, the processor 82 initiates the timer 86 and sends a second signal to the electronic entry devices 80. Upon receiving the second signal, each electronic entry device 80 enables or “unlocks” the device's user interface 94 so that the player may input his or her answer to the game question indicia 12 thereto. For example, prior to receiving the second signal, the user interface 94 of a player's respective electronic entry device 80 is locked and prohibited from receiving an input from the user. When the electronic entry device 80 is locked, the display 92 may display an image or may merely be blank or black. After the electronic entry device 80 receives the second signal from the central computer 74, the user interface 94 thereof is unlocked and a player may input his or her answer to the game question indicia 12 thereto. For example, the display 92 of the electronic entry device 80 may also function as the user interface 94 and be capable of receiving an input from the player with a stylus.

After a predetermined period of time has elapsed (e.g., 60 seconds), as determined by the timer 86 of the central computer 74, the timer 86 of the central computer 74 sends a third signal to the processor 82 of the central computer 74 that is indicative of the predetermined period of time elapsing. After the processor 82 of the central computer 74 receives the third signal, the processor 82 sends a fourth signal to the electronic entry devices 80. Upon receiving the fourth signal, the user interface 94 of each electronic entry device 80 is locked and thus prohibits the players from entering or editing their respective answer to the game question indicia 12. If a player enters his or her final answer prior to the end of the predetermined period of time, the player may also actuate a button 106 on the user interface 94 or device 80 to manually lock his or her electronic entry device 80 and signal that the player has entered his or her final answer. If a player desires to change his or her answer before the predetermined period of time has elapsed, the player may actuate a “clear” button 108 on the user interface 94 or device 80 that clears the player's respective answer from the user interface 94 and/or display 92 of the electronic entry device 80.

After the predetermined period of time for the players to enter an answer on their respective electronic entry device 80 has elapsed and the devices 80 have been locked, the answers input into the electronic entry devices 80 are communicated to the central computer 74 and stored in the memory 84. The answers stored in the memory 84 of the central computer 74 may be selectively communicated to the display 78 so that the players and viewing audience can visualize each player's answer to the game question indicia 12. The players' answers to the game question indicia 12 may be displayed automatically or may be time delayed. The answers may also be displayed as a live video feed. At least one of the game question indicia 12 and the answer 14 to the game question indicia may also be displayed on the display 78. Additionally, the control unit 76 may be actuated by a player or non-player to generate a fifth signal that is communicated to the central computer 74, wherein, upon receiving the fifth signal, the central computer 74 causes the players' answers to the game question indicia 12 to be displayed on the display 78.

If a tie-breaker question indicia 26 is necessary, the control unit 76 may be activated by a player or non-player to generate a sixth signal that is communicated to the central computer 74. Upon receiving the sixth signal, the central computer 74 resets the timer 86, communicates a seventh signal to each of the electronic entry devices 80 to clear the user interfaces 94 of the previous answer to the game question indicia 12 and, optionally, clears the display 92. Generally, the sixth signal resets the game system 72 such that it may be controlled by the player or non-player to receive answers to the tie-breaker question indicia 26 within another predetermined period of time (e.g., 30 seconds) or the same period of time (e.g., 60 seconds). The game system 72 operates substantially the same when configured to receive an answer to the tie-breaker question indicia 26 as when it is configured to receive the players' answers to the game question indicia 12.

The game system 72 may further comprise a game card database that may be stored in the memory 84 of the central computer 74, in an external storage unit/server 112 or in a memory that is in communication with the central computer 74. More specifically, each of the trivia game cards 2, including the question indicia and answers set forth thereon, may be embodied as an electronic trivia game card file that is stored in the game card database. At the start of a hand, the central computer 74 retrieves a particular electronic trivia game card file from the game card database and stores the electronic trivia game card file in the memory 84 of the central computer 74. The electronic trivia game card files may also be retrieved randomly. More specifically, each electronic trivia game card file may be assigned a unique identifier, such as a number, in the game card database. The central computer 74 may include a random number generator such that a random number is generated that corresponds to one of the unique identifiers assigned to a particular electronic trivia game card file in the game card database. The central computer 74 may store the random numbers generated by the random number generator in the memory 84 and compare the random number generated to the previous random numbers generated such that a particular electronic trivia game card file is not retrieved more than once in a particular game. Alternatively, the central computer 74 may store the unique identifier of each electronic trivia game card file retrieved in the memory 84 and, upon the generation of a new random number by the random number generator, compare the new random number with the unique identifiers of the previous retrieved electronic trivia game card files prior to retrieving an electronic trivia game card file for a hand such that a particular electronic trivia game card file is not retrieved more than once.

The player or non-player may actuate the control unit 76 to trigger the retrieval of the electronic trivia game card file at the start of a hand. More specifically, at the start of a hand, the control unit 76 may be actuated to generate a seventh signal that is communicated to the central computer 74. Upon receiving the seventh signal, the central computer 74 retrieves the electronic trivia game card file and stores the electronic trivia game card file in the memory 84. The player or non-player may actuate the control unit 76 to generate an eighth signal that is communicated to central computer 74. Upon receiving the eighth signal, the central computer 74 causes the first question indicia 20 from the electronic trivia game card file to be displayed on the display 78 so as to be viewable to the players and/or audience. Optionally, the central computer 74 may also communicate the first question indicia 20 to the one or more electronic entry devices 80 such that the first question indicia 20 is displayed to the player on the display 92 of the electronic entry device 80. The control unit 76 may also be actuated by a player or non-player to generate additional signals that trigger the display of the second question indicia 22, third question indicia 24, tie-breaker question indicia 26, as well as any answers thereto on the display 92 of the electronic entry device 80 and, optionally, the display 78.

As described previously, the electronic trivia game card database may be stored in the memory 84 of the central computer 74 or may be stored in an external memory, such as an external storage unit/server 112 or a memory stick that is in communication with the central computer 74. The electronic trivia game card database may be updated as needed to include new electronic trivia game card files or electronic trivia game card files specific to a particular trivia category (e.g., literature and language; the arts; pop culture; sports and games; leisure and lifestyle; potpourri; science and technology; history and social sciences; and current events).

In yet another embodiment of the trivia game formed in accordance with the present invention, the game system 72 may be configured such that two or more players can play the trivia game from remote locations. When the game system is utilized, the method of playing the trivia game generally follows the steps described in the preceding paragraphs; however, the central computer 74 controls progression of the game play rather than the control unit 76. Additionally, the players select one of a plurality of possible answers (e.g., preferably five multiple choice answers) displayed on each player's respective electronic entry device 80 after the game question indicia 12 or tie-breaker question indicia 26 is displayed. More specifically, players desiring to play the trivia game formed in accordance with the present invention may open an application or web browser on their respective electronic entry device 80 (e.g., a tablet, a computer or a mobile telephone, etc.) to connect to the central computer 74, which may be embodied as one or more host servers that host a plurality of trivia games and control the game play thereof. Upon establishing a connection with the central computer 74, the players are prompted to select a particular trivia game that they wish to play in. For example, the central computer 74 may host trivia games (e.g., trivia game rooms) specific to a particular trivia category (e.g., literature and language; the arts; pop culture; sports and games; leisure and lifestyle; potpourri; science and technology; history and social sciences; and current events) or randomized categories. Additionally, each trivia game hosted by the central computer 74 may have specific monetary stakes, such as buy-in amounts and prize amounts, and game modes. Furthermore, each trivia game hosted by the central computer 74 may be limited to a specific number of players.

When a player's electronic entry device 80 is connected to the central computer 74, the central computer 74 communicates the available or upcoming trivia games that the player can join. The central computer 74 may also communicate statistics of previous trivia games to the player's respective electronic entry device 80. The electronic entry device 80 displays the available or pending trivia games to the player, and the player actuates the user interface 94 of the electronic entry device 80 to select a particular trivia game that he or she wishes to play. The central computer 74 may further communicate the remaining time for players to join a particular game before the trivia game begins.

Once players have joined a particular trivia game, each player may actuate a portion of the user interface 94 of the electronic entry device 80 to signal that he or she is participating in the hand. For example, the player may actuate a button on the electronic entry device 80 or actuate a button displayed on the user interface 94 thereof to signal that he or she is participating in the hand. The user interface 94 may also display the game table or game board 8 and the fold marker 10 such that the player can interact with the user interface 94 to move the displayed fold marker 10 to the first sub-region 52 of the player's respective game play region 50 that is displayed on the electronic entry device 80. Furthermore, the user interface 94 may display wagering indicia 6 that the player may manipulate during various states of game play (e.g., during betting rounds), as described in the previous paragraphs.

Once the players have joined a particular trivia game and wagered any required blinds, after a predetermined period of time, the central computer 74 retrieves a particular electronic trivia game card file from the game card database and stores the electronic game card file in the memory 84 of the central computer 74 to start the hand. Preferably, there is a 30 second timer for a player to decide to bet or fold (if time expires, the player folds automatically). After a predetermined period of time, the central computer causes the first question indicia 20 from the electronic trivia game card file to be displayed on each player's respective electronic entry device 80. As in the previous embodiments, after the first question indicia 20 is displayed, a round of betting is conducted in which players interact with the user interface 94 of their respective electronic entry device 80 to either fold, check, bet, call or raise. Each player's particular wagering during the betting round is communicated from each player's electronic entry device 80 to the central computer 74. The central computer 74 may tabulate the bets and calculate the amount of wagering indicia 6 that is in the central pot. As each player wagers during the betting round, each player's specific wager is communicated to the electronic entry devices 80 and displayed thereon so that each player can see the other players' wagering during the round. After each player's allocated period of time to wager during the betting round has ended, the central computer 74 signals to the electronic entry devices 80 that the betting round has ended. The tabulated wagers of the players calculated by the central computer (e.g., the amount of wagering indicia in the center pot region 56) are also communicated to the electronic entry devices 80 and displayed thereon. After a predetermined amount of time, the second question indicia 22 is communicated to the electronic devices 80 and the game continues following the methodology set forth in the previous paragraphs; however, wagering is conducted via the user interface 94 of each electronic entry device 80.

When the game question indicia 12 is communicated to the electronic entry devices 80 and displayed thereon, a plurality of possible answers (e.g., preferably five multiple choice answers) are displayed on the electronic entry devices 80. Each player actuates the user interface 94 of his or her respective electronic entry device 80 to select his or her answer to the game question indicia 12 from the displayed multiple choice answers. As set forth in the previous paragraphs, the players are allocated a predetermined amount of time to select an answer to the game question indicia 12. When the game question indicia 12 appears, there is preferably a 10 second timer for a player to select his or her answer (if time expires, the player folds automatically). After the central computer 74 determines that the predetermined amount of time has ended, each player's respective electronic entry device 80 communicates the player's answer to the game question indicia 12 to the central computer 74. The central computer 74 compares the players' answers to the game question indicia 12 to the answer 14 to the game question indicia 12 set forth in the electronic trivia game card file to determine which player(s) answered the game question correctly. As set forth in the previous paragraphs, if a tie-breaker question is necessary, the central computer 74 communicates the tie-breaker question indicia 26 to the electronic entry devices 80 and each player is prompted to select a numerical answer thereto. After a predetermined amount of time has elapsed for the players to enter their answers to the tie-breaker question indicia 26, the electronic entry devices 80 communicate the players' answers to the central computer 74. The central computer 74 compares the players' answers to the tie-breaker question indicia 26 to the answer 28 to the tie-breaker question indicia 26 set forth in the electronic trivia game card file to determine which players correctly answered the tie-breaker question indicia 26 or had the answer closest to the correct answer.

After the end of the hand, the tabulated wagering indicia 6 may awarded to the winning player or divided among several winning players. Each player's wagering indicia 6 may be stored in a wagering database such that the player may “cash out” for credits or currency after one or a series of hands.

There will be different game modes possible such as including betting limits, having some rooms (e.g., online trivia game play rooms) with higher or lower blinds and maximum or minimum bets, limiting the number of players, having different trivia game play rooms with different numbers of “seats” (available slots for players) and having prize structures (e.g., different rooms will have different prize structures, such as: winner takes all, game ends when one person has won all the chips, and the winner keeps all the chips, tournament-style, game ends when one person has won all the chips, but the total pot is divided up between the players from 1st to Nth place (e.g., the player who wins all the chips wins 70% of the total and the player who was the last person to lose all his or her chips (i.e. the runner up) wins 30% of the total). Additionally, there could be question limits (e.g., there is a limit of N number of questions after which the game ends; players keep all the chips they have after the final question is read, answered, and resolved).

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A trivia game for two or more players, which comprises:
at least one trivia game card component;
at least a first question indicia, a game question indicia and an answer to the game question indicia formed as part of the at least one trivia game card component, wherein the first question indicia comprises a first trivia category and the game question indicia comprises a question common to the first trivia category; and
at least two entry devices.

2. A trivia game as defined by claim 1, wherein each entry device of the at least two entry devices includes a user interface, the user interface being configured to receive at least one input from each player of the two or more players, wherein the at least one input from each player of the two or more players corresponds to the answer to the game question indicia of each player of the two or more players.

3. A trivia game as defined by claim 2, which further comprises:
a central computer, the central computer having a processor, a memory, a user interface and a display, each of the memory, the user interface and the display being in communication with the processor, wherein the central computer is in communication with the at least two entry devices;
wherein each entry device of the at least two entry devices further includes a display;
wherein at least one of the first question indicia, the game question indicia and the answer to the game question indicia are input into the central computer through the user interface thereof and stored in the memory;
wherein the central computer selectively communicates at least one of the first question indicia and the game question indicia to the at least two entry devices and causes at least one of the first question indicia and the game question indicia to be selectively displayed on the display of each entry device of the at least two entry devices;
wherein each entry device of the at least two entry devices communicates the answer to the game question indicia of each player of the two or more players to the central computer; and
wherein the central computer communicates the answer to the game question indicia of each player of the two or more players to the display of the central computer and causes the display of the central computer to display the answer to the game question indicia of each player of the two or more players.

4. A trivia game as defined by claim 1, wherein the at least one trivia game card component is embodied as an electronic trivia game card file; and
wherein each of the first question indicia, the game question indicia and the answer to the game question indicia is electronically embedded in the electronic trivia game card file.

5. A trivia game as defined by claim 1, wherein the at least one trivia game card component has a first side and second side disposed opposite the first side; and
wherein each of the first question indicia, the game question indicia and the answer to the game question indicia is imprinted on one of the first side and the second side.

6. A trivia game as defined by claim 5, which further comprises:
a card reader, the card reader having a housing defining an internal cavity;
wherein the at least one trivia game card component is at least partially received within the internal cavity of the card reader;
wherein the housing at least partially obscures at least one of the first question indicia, the game question indicia and the answer to the game question indicia; and
wherein the at least one trivia game card component is selectively removable from the internal cavity of the card reader such that at least one of the first question indicia, the game question indicia and the answer to the game question indicia is visible.

7. A trivia game as defined by claim 1, wherein the trivia game card component further comprises:
at least one of a second question indicia, a third question indicia, a tie-breaker question indicia and an answer to the tie-breaker question indicia;
wherein the second question indicia comprises a second trivia category and the third question indicia comprises a third trivia category;
wherein the second trivia category is a subcategory of the first trivia category;
wherein the third trivia category is a subcategory of the second trivia category; and
wherein the game question indicia comprises a question common to the first through third trivia categories.

8. A trivia game as defined by claim 1, which further comprises:
at least one of a game table and a game board;
wherein the at least one of a game table and a game board includes at least one game play region for each player of the two or more players; and
wherein the at least one game play region includes at least a first sub-region, a second sub-region and a center pot region.

9. A trivia game as defined by claim 8, which further comprises:
at least one fold marker for each player of the two or more players, wherein each fold marker is selectively positionable in the first sub-region of the respective game play region of each player of the two or more players; and
wagering indicia, wherein the wagering indicia is selectively positionable in at least one of the second sub-region of the respective game play region of each player of the two or more players and the center pot region.

10. A trivia game as defined by claim 1, which further comprises a timer.

11. A method of playing a trivia game for two or more players, the trivia game including at least one trivia game card component and at least two entry devices, the at least one trivia game card component having at least a first question indicia, a game question indicia and an answer to the game question indicia, wherein each entry device of the at least two entry devices is assigned to a respective player of the two or more players, the method of playing the trivia game comprising the steps of:
retrieving the first question indicia from the trivia game card component;
communicating the first question indicia to each player of the two or more players;
initiating at least a first betting round;
retrieving the game question indicia from the trivia game card component;
communicating the game question indicia to each player of the two or more players;
initiating a first answering round, wherein the step of initiating the first answering round comprises the sub-step of receiving answers to the game question indicia from each player of the two or more players on the entry devices; and
comparing the received answers to the answer to the game question indicia.

12. A method of playing a trivia game as defined by claim 11, wherein the trivia game card component further comprises at least one of a second question indicia, a third question indicia, a tie-breaker question indicia and an answer to the tie-breaker question indicia, wherein the method of playing the trivia game further comprises the steps:
communicating at least one of the second question indicia, the third question indicia and the tie-breaker question indicia to each player of the two or more players;
initiating at least one of a second betting round, a third betting round and a second answering round, wherein the step of initiating the second answering round comprises the sub-steps of receiving answers to the tie-breaker question indicia from each player of the two or more players and comparing the received answers to the answer to the tie-breaker question indicia.

13. A method of playing a trivia game as defined by claim 12, wherein the first question indicia comprises a first trivia category, the second question indicia comprises a second trivia category and the third question indicia comprises a third trivia category;
wherein the second trivia category is a subcategory of the first trivia category;
wherein the third trivia category is a subcategory of the second trivia category; and
wherein the game question indicia comprises a question common to the first through third trivia categories.

14. A method of playing a trivia game as defined by claim 12, wherein the answer to the tie-breaker question is numerical.

15. A method of playing a trivia game as defined by claim 12, wherein the step of initiating the second answering round further comprises the sub-step of allocating a predetermined period of time for each player of the two or more players to provide the answer to the tie-breaker question indicia.

16. A method of playing a trivia game as defined by claim 11, wherein the step of initiating a first answering round further comprises the sub-step of allocating a predetermined period of time for each player of the two or more players to provide the answer to the game question indicia.

17. A trivia game system for two or more players, which comprises:
a central computer, the central computer having a processor and a memory in communication with the processor;
at least one electronic game card file, wherein the at least one electronic game card file is stored in the memory of the central computer, the at least one electronic game card file comprising at least a first question indicia, a game question indicia and an answer to the game question indicia;
at least two entry devices, wherein each entry device of the at least two entry devices is in communication with the central computer, wherein each entry device of the at least two entry devices includes a processor, a user interface in communication with the processor and a display in communication with the processor;
wherein the central computer selectively communicates at least one of the first question indicia and the game question indicia to the at least two entry devices and causes at least one of the first question indicia and the game question indicia to be selectively displayed on the display of each entry device of the at least two entry devices;
wherein the user interface of each entry device of the at least two entry devices is configurable to receive an input from a respective player of the two or more players corresponding to the answer to the game question indicia of the respective player, wherein the at least two entry devices communicate the answer to the game question indicia of the respective player to the central computer; and
wherein the central computer compares the answer to the game question indicia of each respective player of the two or more players to the answer to the game question indicia embedded in the electronic game card file.

18. A trivia game system as defined by claim 17, wherein the central computer further comprises a timer in communication with the processor.

19. A trivia game system as defined by claim 17, which further comprises:
at least one external data storage system, the at least one external data storage system being in communication with the central computer.

20. A trivia game as defined by claim 19, wherein the at least one electronic game card file is stored in the external data storage system.

21. A trivia game system as defined by claim 17, wherein the at least one electronic game card file further comprises at least one of a second question indicia, a third question indicia, a tie-breaker question indicia and an answer to the tie-breaker question indicia;
wherein the second question indicia comprises a second trivia category and the third question indicia comprises a third trivia category, wherein the second trivia category is a subcategory of the first trivia category, wherein the third trivia category is a subcategory of the second trivia category and wherein the game question indicia comprises a question common to the first through third trivia categories; and
wherein the central computer selectively communicates at least one of the second question indicia, the third question indicia, the tie-breaker question indicia and the answer to the tie-breaker question indicia to the at least two entry devices and causes at least one of the second question indicia, the third question indicia, the tie-breaker question indicia and the answer to the tie-breaker question indicia to be selectively displayed on the display of each entry device of the at least two entry devices.

22. A trivia game as defined by claim 21, wherein the user interface of each entry device of the at least two entry devices is configured to receive an input from a respective player of the two or more players corresponding to the answer to the tie-breaker question indicia of the respective player, wherein each entry device of the at least two entry devices communicates the answer to the tie-breaker question indicia of each player of the two or more players to the central computer; and
wherein the central computer compares the answer to the tie-breaker question indicia of each respective player of the two or more players to the answer to the tie-breaker question indicia embedded in the electronic game card file.

23. A method of playing a trivia game for two or more players with a trivia game system, the trivia game system comprising a central computer, the central computer having a processor and a memory in communication with the processor, at least one electronic game card file stored in the memory of the central computer, the at least one electronic game card file comprising at least a first question indicia, a game question indicia and an answer to the game question indicia and at least two entry devices, wherein each entry device of the at least two entry devices is in communication with the central computer, wherein each entry device of the at least two entry devices includes a processor, a user interface in communication with the processor and a display in communication with the processor, the method of playing the trivia game comprising the steps of:
communicating the first question indicia from the central computer to each entry device of the at least two entry devices;
displaying the first question indicia on the display of each entry device of the at least two entry devices;
initiating a first betting round;
communicating the game question indicia from the central computer to each entry device of the at least two entry devices;
displaying the game question indicia on the display of each entry device of the at least two entry devices;
initiating a first answering round, wherein the step of initiating the first answering round comprises the sub-step of receiving at least one input from each player of the two or more players on the user interface of each entry device of the at least two entry devices, wherein the at least one input from each player of the two or more players corresponds to the answer to the game question indicia of each player of the two or more players;
communicating the answer to the game question indicia of each player of the two or more players from each entry device of the at least two entry devices to the memory of the central computer and storing the answer to the game question indicia of each player of the two or more players therein; and
comparing by the central computer the answer to the game question indicia of each player of the two or more players to the answer to the game question indicia embedded in the electronic game card file.

24. A method of playing a trivia game with a trivia game system as defined by claim 23, wherein the at least one electronic game card file further comprises at least one of a second question indicia, a third question indicia, a tie-breaker question indicia and an answer to the tie-breaker question indicia, wherein the second question indicia comprises a second trivia category and the third question indicia comprises a third trivia category, wherein the second trivia category is a subcategory of the first trivia category, wherein the third trivia category is a subcategory of the second trivia category and wherein the game question indicia comprises a question common to the first through third trivia categories, wherein the method of playing the trivia game with the trivia game system further comprises the steps of:
communicating at least one of the second question indicia, the third question indicia, the tie-breaker question indicia and the answer to the tie-breaker question indicia from the central computer to the at least two entry devices;
displaying at least one of the second question indicia, the third question indicia, the tie-breaker question indicia and the answer to the tie-breaker question indicia on the display of each entry device of the at least two entry devices; and
initiating at least one of a second betting round, a third betting round and a second answering round, wherein the step of initiating the second answering round comprises the sub-steps of receiving at least a one second input from each player of the two or more players on the user interface of each entry device of the at least two entry devices, wherein the at least one second input from each player of the two or more players corresponds to the answer to the tie-breaker question indicia of the respective player, communicating the answer to the tie-breaker question indicia of each respective player of the two or more players from the at least two entry devices to the memory of the central computer and storing the answers to the tie-breaker questions therein, and comparing by the central computer the answer to the tie-breaker question indicia of each respective player of the two or more players to the answer to the tie-breaker question indicia embedded the electronic game card file.
